(19) United States
(12) Patent Application Publication
(10) Pub. No.: US 2019/0005573 A1
(43) Pub. Date: Jan. 3, 2019

(54) INVENTORY MANAGEMENT PLATFORM

(71) Applicant: Dentomatix LLC, El Cajon, CA (US)

(72) Inventor: Nathan Hornsby, El Cajon, CA (US)

(21) Appl. No.: 16/015,068

(22) Filed: Jun. 21, 2018

Related U.S. Application Data
(60) Provisional application No. 62/528,432, filed on Jul. 3, 2017.

(51) Int. Cl. G06Q 30/06; G06Q 10/08; G06Q 30/02

(52) U.S. Cl. CPC G06Q 30/0641; G06Q 30/0282; G06Q 10/087

(57) ABSTRACT

The disclosed inventory management platform includes an online shopping portal that can include multiple carts (one for a number of branch offices). Further, the online shopping portal includes tiered login information with differing permissions. One tier is able to request items, another is able to add items to a cart, and a third is able to execute the purchase. The online shopping portal further includes a commonly purchased item list. A further tier of user is able to rate items and provide feedback to the higher tiers about the effectiveness of a given item despite being unable to affect inventory management.

### CROSS-REFERENCE TO RELATED APPLICATION(S)

The present application claims the benefit of U.S. Provisional Patent Application No. 62/528,432, entitled “INVENTORY MANAGEMENT PLATFORM,” and filed Jul. 3, 2017, which is incorporated herein in its entirety.

### TECHNICAL FIELD

The disclosure relates to a web platform for managing inventory of a number of branch offices and more particularly to varied levels of permission or authority in engaging with the platform.

### BACKGROUND

A significant percentage of supply ordering (particularly in medical offices) is performed via printed catalogs and order forms. This process is cumbersome, disorganized, and often requires a lot of synchronized coordination between various employee tiers at particular times.

### BRIEF DESCRIPTION OF THE DRAWINGS

FIG. 1 is a block diagram of an inventory management system.

FIG. 2 is an illustration of branch-cart selection interface.

FIG. 3 is an illustration of an invoice management interface.

FIGS. 4A and 4B are illustrations of an analytical chart interface.

FIG. 5A is an illustration of a direct add-to-cart interface.

FIG. 5B is an illustration of a commonly used item interface.

FIG. 6A is an illustration of a request list to cart interface.

FIG. 6B is an illustration of a request list interface from a requestor's point of view.

FIG. 7 is an illustration of an inventory management automatic cart increment screen.

FIG. 8 is a sequence diagram of interface use.

FIG. 9 is a flowchart illustrating integration of an inventory system with a procedure management system.

FIG. 10 is a block diagram illustrating a computer operable to implement the disclosed technology according to some embodiments of the present disclosure.

### DETAILED DESCRIPTION

An example of the inventory management platform may be illustrated with a number of connected dental offices. A dental office is a service provider that through the course of service uses a number of consumables, many of which are frequent purchases (e.g., brushes, acrylics, implants, fluoride, polish, numbing agents, etc.). In some cases, a licensed doctor (dentist) is required to actually execute or authorize purchases. Administrative tasks take away from the doctor performing more critical tasks. The burden of administrative tasks is exacerbated when the given doctor manages more than one office (clinic). However, it is unnecessary for the doctor to actually set up a purchase order.

The disclosed web platform includes an online shopping portal that can include multiple carts (one for each branch office). Further, the online shopping portal includes tiered login information with differing permissions. A first tier is able to request items, another is able to add items to a cart, and a third is able to execute the purchase. The online shopping portal further includes a commonly purchased item list. A further tier of users is able to rate items and provide feedback to the higher tiers about the effectiveness of a given item despite being unable to affect inventory management and acquisition. The first tier of users is able to grant any of the permissions and controls available to the first tier to any of the lower tiers, or specific members of the lower tiers. The granting of additional permissions/controls can be performed on a waive-in or ad-hoc basis. On an ad-hoc basis, permissions/controls are selected individually (e.g., purchase control, multiple cart control. Etc.). On a waive-in basis, permissions/controls are selected on a tier level (e.g., granting a full tier's permissions/controls to a lower tier or a specific user of a lower tier).

The inclusion of management of multiple carts by a single account provides a computational advantage over other ecommerce systems known in the art. Dissociating a user from a single cart reduces the overall processing load on the system and provides an advantage in the operation of the hardware upon which the system operates. Further, the organization of the users into multiple tiers reduces the overall requests on the system, thereby reducing the computational processing load and server/network requests across the system compared to other known ecommerce platforms.

There is also a vendor tier, wherein a vendor is able to enter the shopping platform as a marketplace and import a list of available goods. Further, vendors may participate in the marketplace via a web object or API integrated on their website. The API enables the online shopping platform to be used from the vendor's website site and accesses a user's stored login and history data. If the vendor doesn't have a website of an e-commerce platform, the online shopping platform 22 creates a specifically branded platform for the vendor. If the vendor does have a website, but no e-commerce platform, the online shopping platform 22 is linked to the vendor's website via a web object or vendor specific URL that allows the vendor's specific branding. If the vendor has a website and e-commerce functionality, the online shopping platform 22 is linked via a widget or specific URL for customers of the system 20 to recognize and shop through.

In use, a requestor-level user requests products for a branch specific cart, an administrative level user modifies requested items, and a purchasing level user is able to execute purchases for carts of offices the purchasing level user has authority over. When items arrive, and are used at the office, employees of any tier, including a fourth, lower tier, are able to rate the items and provide both platform wide feedback and purchasing entity (office and system-wide) ratings.

While the above example was discussed in view of a number of co-managed dental offices, the platform could be used for a number of different industries requiring inventory management. Examples of such industries include: medical clinics, auto repair, military, cosmetics/beautician, or other suitable industries that frequently purchase inventory.

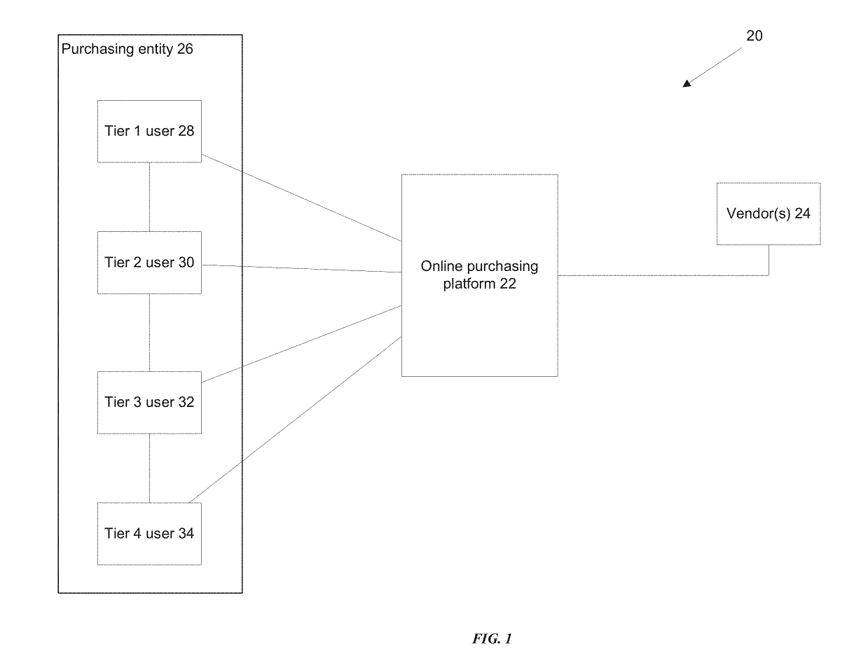

FIG. 1 is a block diagram of an inventory management system 20. The disclosed inventory management system 20 includes a number of entities engaging with an online shopping platform 22. The online shopping platform 22 includes a number of features are similar to known online shopping platform such as Amazon.com, Walmart.com, Overstock.com, and other suitable, known e-commerce platforms in the art. The online shopping platform 22 includes a marketplace connection with a vendor 24 or vendors. Each vendor 24 is able to offer items on the online purchasing platform 22. The items may be added to a shopping cart by a purchasing entity 26, and purchased.

The purchasing entity 26 refers to the inventory management arm of a business. The purchasing entity 26, through its members, may manage a single branch office or multiple branch offices of the business. The members of the purchasing entity 26 are subdivided into 4 tiers. The tier-one user 28 is the user or users that executes purchases, manages user assignment, complies with licensure requirements and oversees location-relevant inventory and budgets. The tier-two user 30 is the user or users that modifies, fills, and purchases from a shopping cart 42. The tier-three user 32 is able to request items for the tier-two user 30 add to the shopping cart. The tier-four user 34, like all other tiers of users, is able to request products and rate items purchased through the online purchasing platform 22. In some embodiments, each tier user includes all functionality of the lower tiers. In some embodiments, the tier-two user 30 rates vendors (as opposed to products), while the tier-four user 34 rates products (rather than handle vendor relations).

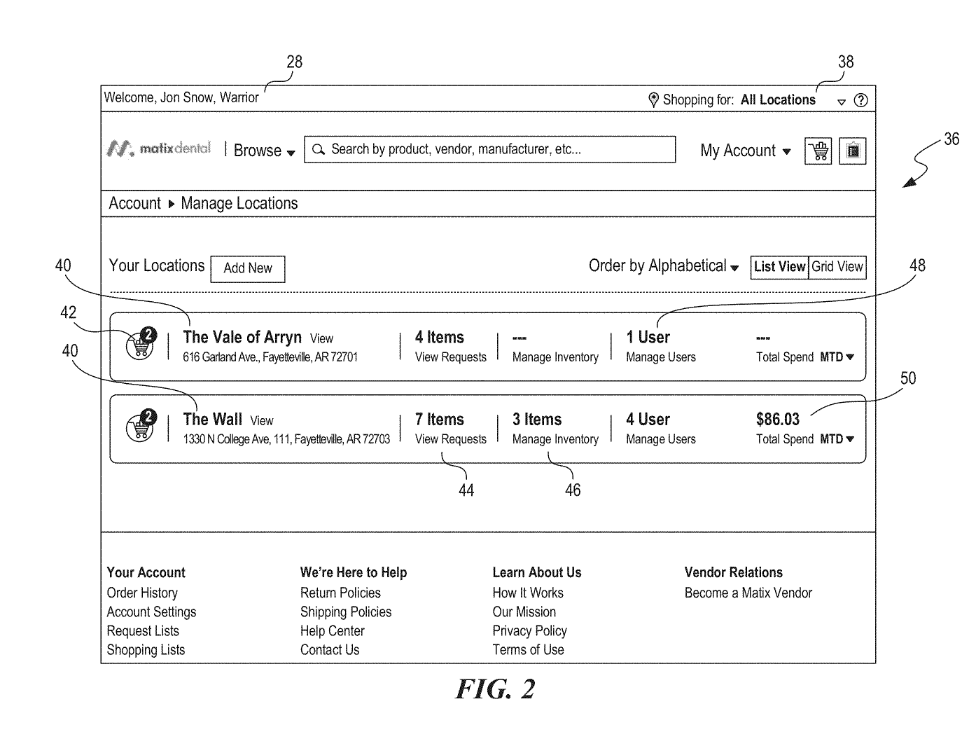

FIG. 2 is an illustration of branch-cart selection interface 36. FIG. 2 is from the perspective of a tier-one user 28. The tier-one user 28 is identified on the top left of the interface along with a title. On the top right is a branch indicator 38 where the branch interface 36 indicates the particular branch the user is reviewing. In the center of the screen each branch 40 is displayed and may be selected individually. Each branch 40 is displayed within the individual address. Further, each branch 40 has an associated cart 42. Each branch 40 and its associated cart 42 are managed individually. Branches 40 further has individual request lists 44.

Request lists 44 differ from carts 42 in that items from the request lists 44 may not actually be purchased until approved by a tier with purchasing authority. Rather, users closest to the usage of items, and most able to determine when additional items or supplies are required are able to request items. Requested items appear on the request list 44. Next to the request list 44 is a branch inventory management screen 46. Each branch 40 includes in inventory management screen 46.

Branches 40 further include account and permissions management 48. Once selected, a tier-one user 28 is able to amend the number of users and the tiers assigned thereto and the online shopping platform 22. Each branch 40 further has an analytic tracking screen 50 that generates reports for inventory expenditure within each branch 40.

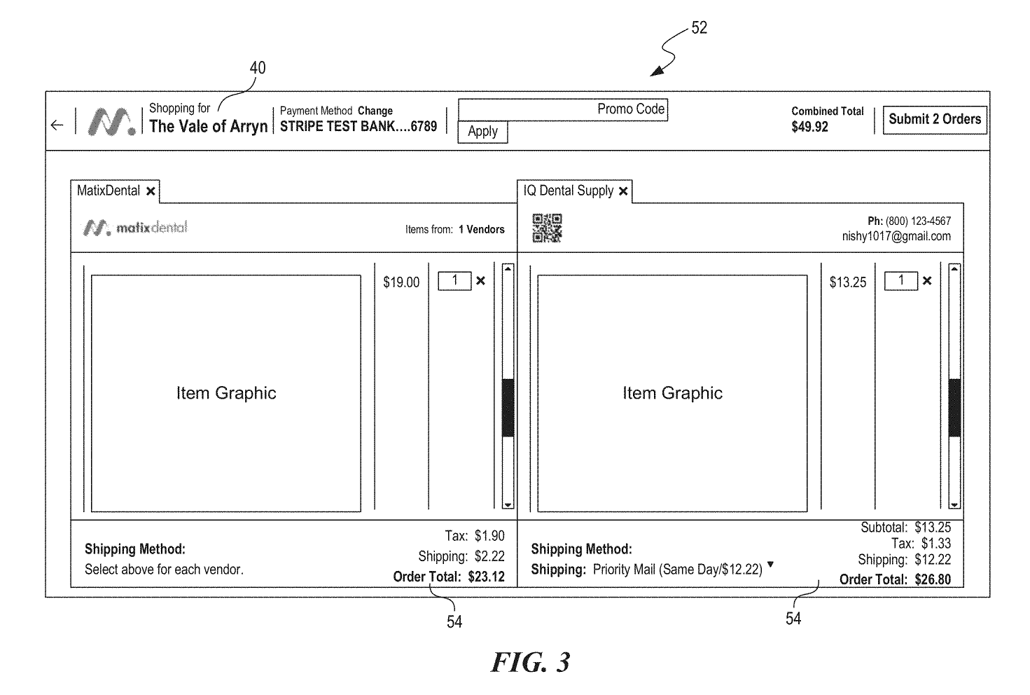

FIG. 3 is an illustration of an invoice management interface 52. The invoice management interface 52 operates under a designated branch 40 and provides the means for a tier-one user 28 or tier-two user 30 to make purchases from the cart 42. The invoice management interface 52 displays vendor invoices 54 from each vendor having items within the branches cart 42. The vendor invoices 54 may be edited for quantity of each item included. As displayed in figure there are two vendor invoices 54 each combining to a total, with shipping, of $49.92. The tier-one user 28 or tier-two user 30 is also enabled to submit the two orders to each of the vendors and processed payment in any suitable way known in the art.

Prior to reaching the invoice management interface 52, a tier-two user 30 will have filled the cart 42 for the tier-one user 28. Because the cart is pre-populated, the tier-one user 28 only need briefly review each vendor invoice 54 prior to submitting the order. Where licensure is required for purchase of certain items the tier-one user 28 verifies their professional license with the online shopping platform 22 prior to submitting orders.

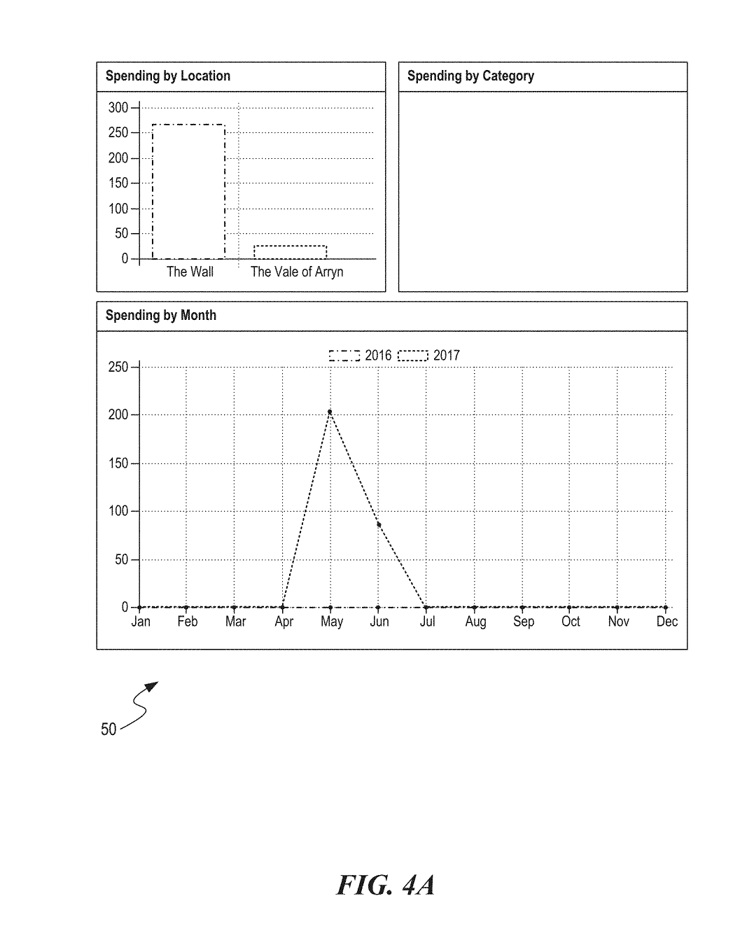

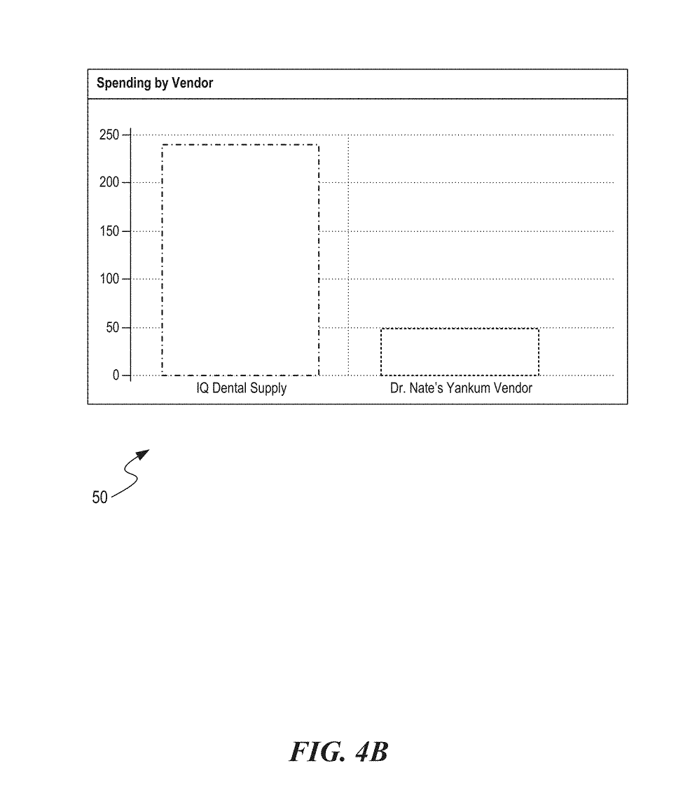

FIGS. 4A and 4B are illustrations of an analytical chart interface 50. Analytical charts 50 are available to tier-one users 28. Each provides detail upon expenditures with given vendors over some predetermined period of time.

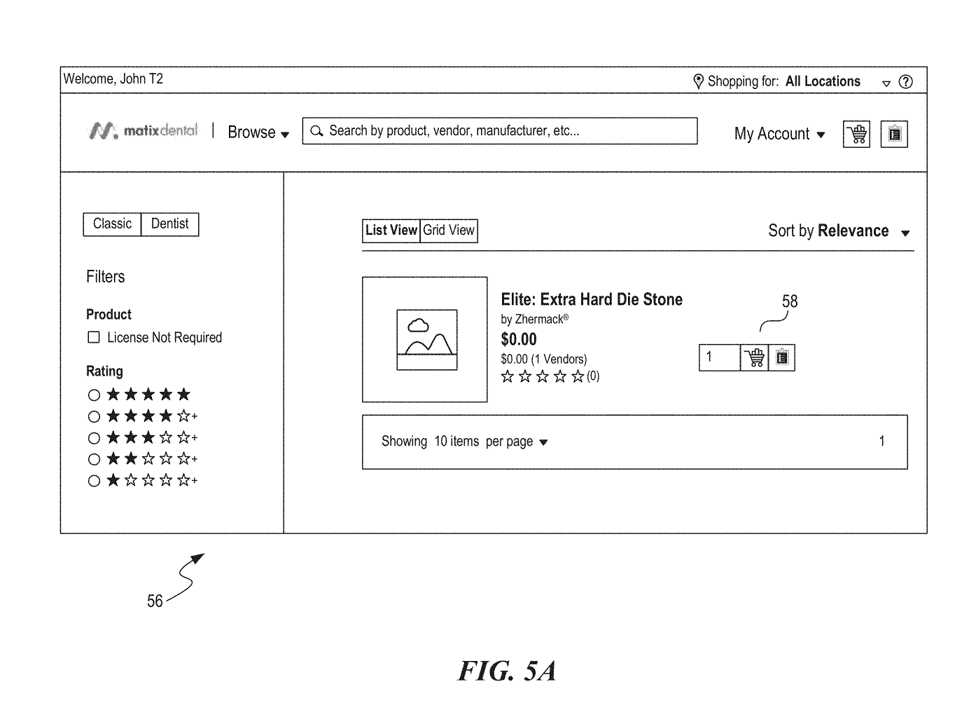

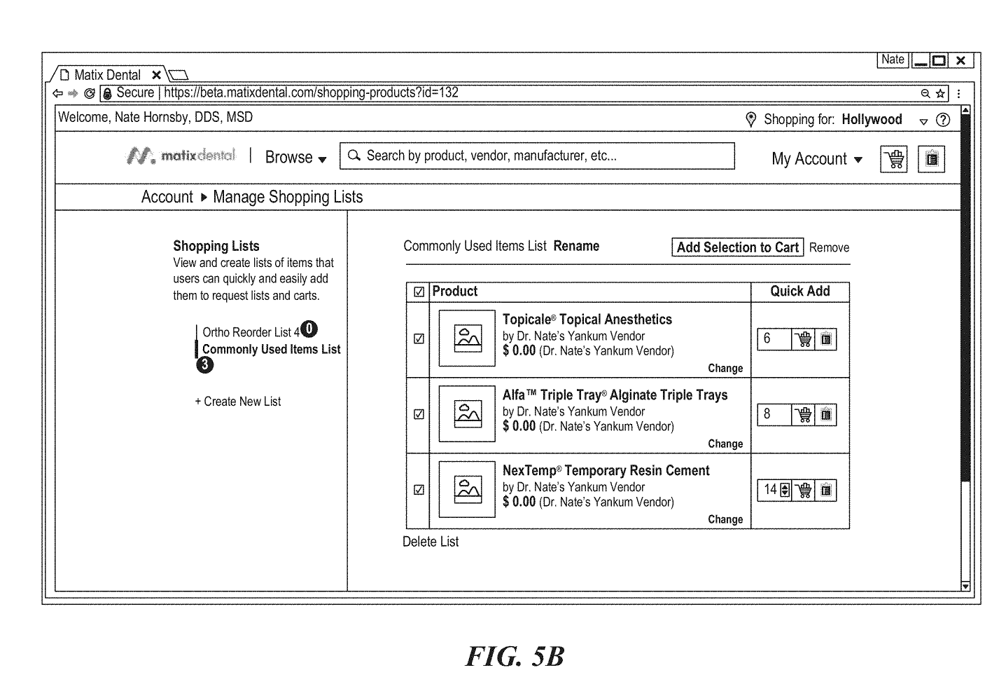

FIG. 5A is an illustration of a direct add-to-cart interface 56. Tier-two users 30 are able to search by product and add items directly to the cart 42. In some embodiments, the add to cart interface 56 appears on a vendor's website rather than the online shopping platform 22. The add to cart interface 56 includes cart controls 58. The vendor may include a web widget/object that enables a given web browser that is logged into the online shopping platform 22 to actively participate in the online shopping platform 22 through the vendor's website via the web object. Using the browser widget, the vendor is able to present their own marketing and page layout while still taking advantage of the organizational systems of the inventory management system 20.

Similar cart controls 58 are included in the web object on the vendor's website and update the carts 42 of the purchasing entity 26 upon receiving commands from the tier-one or two users 28, 30. In some embodiments, the tier-two user 30 is only associated with a single given branch 40. The interactions with the cart on a vendor website automatically defaults to the branch 40 of the tier-two user 30. Where a tier-one user 28 engages with cart controls 58 on a vendor's website, the cart 42 of the currently set branch 40 from the branch select interface 36 is used. If no current branch is set the web object on the vendor's website will prompt the tier-one user 28 to select a branch 40.

FIG. 5B is an illustration of a commonly used item interface. One method to improve efficiency of the online shopping platform 22 is to include commonly used items. Such a list may be used by requestor users or cart controlling users. The commonly used items list enables users to request or add items to the cart based on the frequency of ordering rather than individually searching for each item.

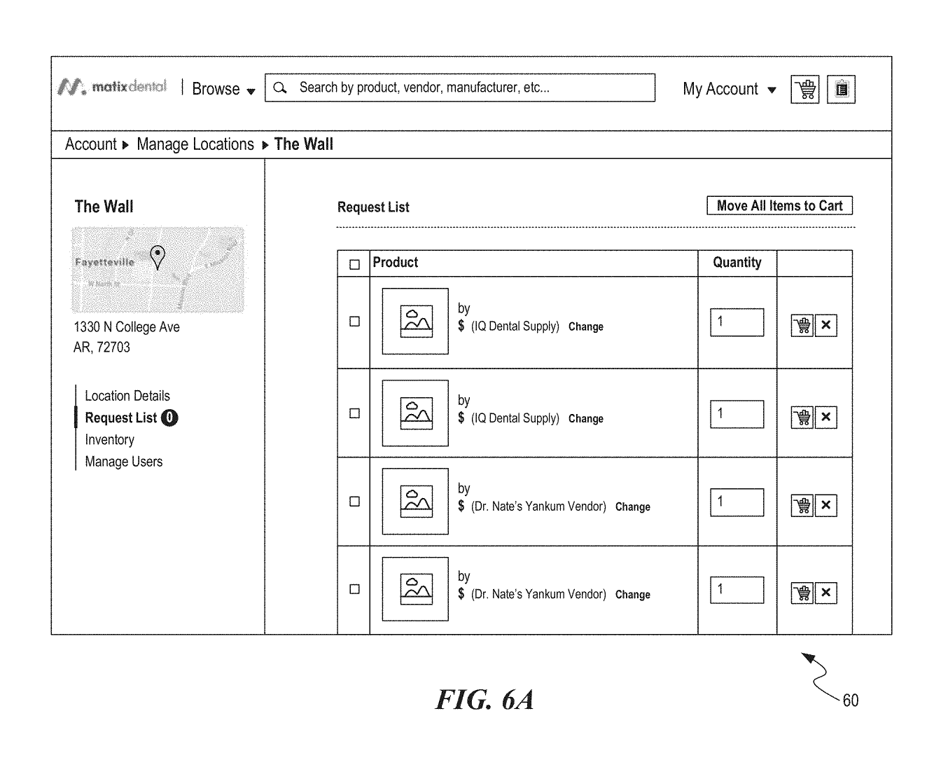

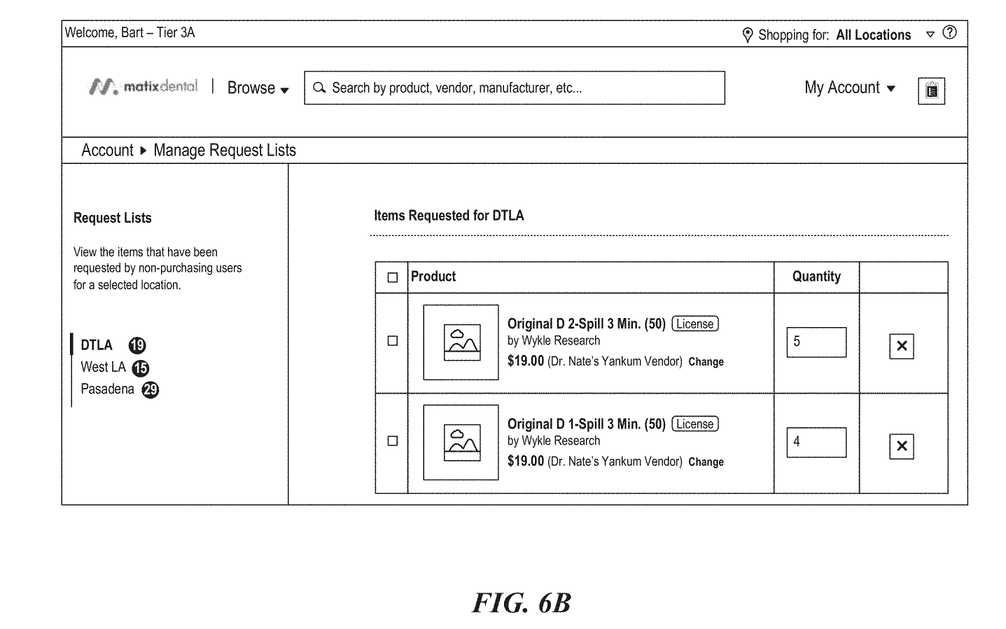

FIG. 6A is an illustration of a request list 60 to cart interface. The request list 60 is displayed from the perspective of a tier-two user 30. The tier-three user 32 inserts items onto the request list 60 given branch 40. The tier-two user 30 is able to review the request list 60 by adding each item to the cart 42, changing the selected item, or amending the quantity of purchase. In some embodiments, the tier-two user 30 is administrator for the purchasing entity 26. The tier-three user 32 is a service technician (of varying degrees of authority). In use, the tier-three user 32 requests items that the tier-two user 30 reviews before adding to cart 42.

FIG. 6B is an illustration of a request list 60 interface from a requestor's point of view. Increasing or decreasing the quantity happens automatically when the tier-three user 32 presses up or down. When the tier-three user 32 submits an item to the request list, that item is displayed on the interface of FIG. 6B. While shopping, the tier-three user 32 presses a request purchase button while interacting with the marketplace. The marketplace operates as a suitable marketplace known in the art does, with the exception that a purchase button is instead a request for the tier-three user 32.

In some embodiments, when the tier-three user 32 as an identity request list 60, the online shopping platform 22 sends a notification to a higher tier user (tiers one or two) concerning the item request. The notification may be sent to contact information associated with the higher tier user and that user's account. The notification may include an email, a web application notification, or a mobile application notification (e.g., a push notification).

The request list 60 may operate similarly to the cart 42 with respect to vendor websites making use of a web object. The tier-three user 32 is thus able to request items via the vendor's website in the same manner that a higher tier user (tiers one or two) may add to the cart 42 at a website other than the online shopping platform 22.

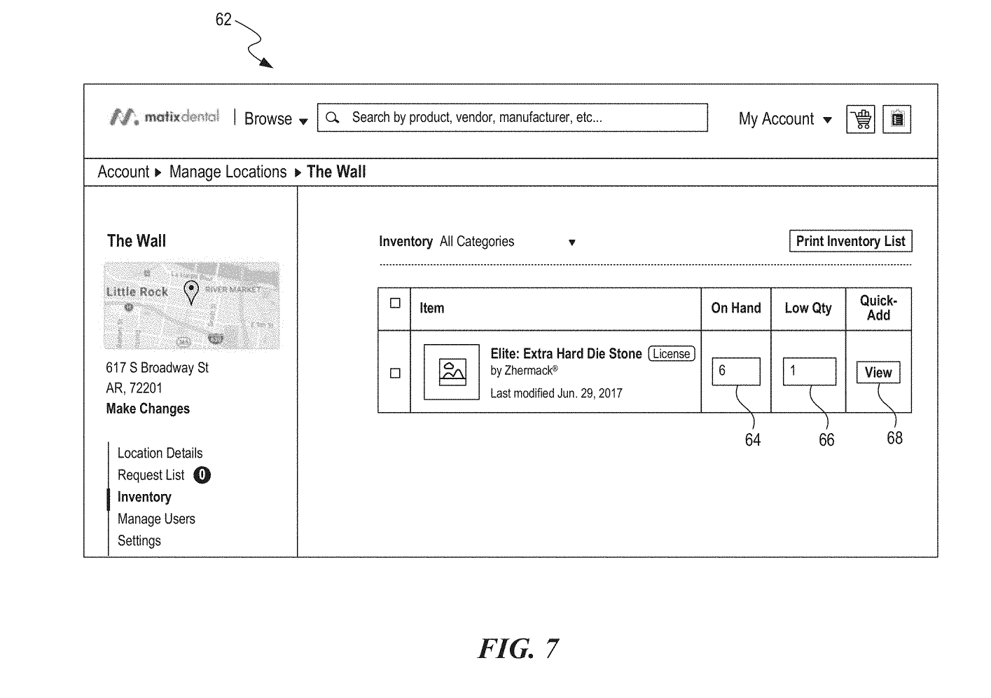

FIG. 7 is an illustration of an inventory management, automatic request increment interface 62. The automatic request increment interface 62 is accessed via the inventory management controls 46 (see. FIG. 2). Tier-three users 32 are able to adjust the number of a given item the given branch 40 has locally with an on-hand counter 64. In some embodiments, the on-hand counter 64 may be adjusted automatically by connection to a 3^{rd} party patient management system via API. Once item counter number hits a low quantity setting 66, the platform 22 automatically adds new inventory to the request list 60. When a shipment is marked as received, the on-hand counter 64 is increased to match the current count. A quick-add menu 68 enables the tier-three user 32 to adjust settings for the automatic request feature. Examples of such settings include size of automatic request and vendor preference.

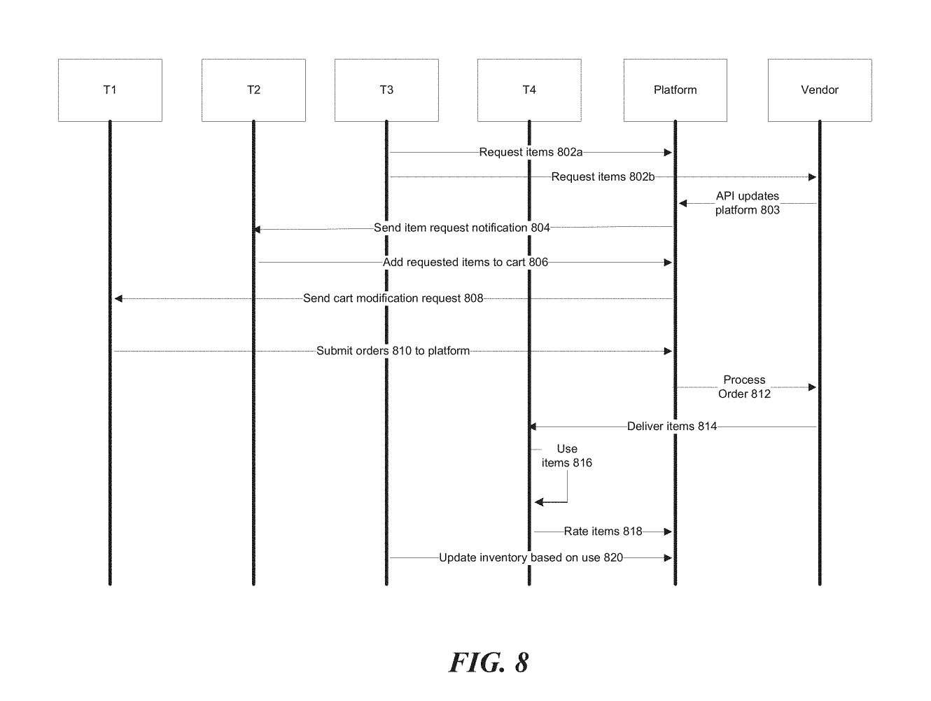

FIG. 8 is a sequence diagram of interface use. In step 802, a tier-three user requests items. Step 802 is broken down into steps “a” or “b”. The requests may a) be directed through the platform, or b) be directed through a vendor's website. In the event of step 802b occurring, the method proceeds to step into 803.

In step 803, the web object confirms that the user (in this case, a tier-three user) is logged into the online shopping platform, identifies the user as associated with a given purchasing entity, evaluates the user's permissions, and updates the purchasing entity's order status. The order status may vary based on the permissions of the given user. The case of the tier-three user, the item update is directed to the request list, though other tiers of users may be updating the cart. The web object further checks which branch of the given purchasing entity the user is actively updating.

In step 804, the platform sent an item request notification to a tier-two or higher user. The notification may be sent to contact information associated with the higher tier user and that user's account. The notification may include an email, a web application notification, or a mobile application notification (e.g., a push notification). Push notifications help prevent requests from sitting unaddressed prolonged period of time. The tier-one or two users are made aware of the tier-three users requests. The notifications may be sent immediately, or at a predetermined interval (such as once a month, weekly, or biweekly).

In step 806, the tier-one or two user interfaces with the online shopping platform to move items from the request list to the cart. The tier-two user is given controls to edit the request list before adding items to the cart. In step 808, the online shopping platform sends a cart notification to a tier-one user. The tier-one user is enabled to modify the cart in the same manner as the tier-two user. The tier-one user is notified in a similar manner as the tier-two user is from item requests.

In step 810, the tier-one or two user reviews the cart including separate invoices from various vendors and sends an order. The tier-one user is able to amend the cart as appropriate before submitting an order. The tier-one or two user performs review and order submission on the online shopping platform on a branch-by-branch and cart-by-cart basis. During review, the tier-one or two users may additionally review analytics and statistics for inventory purchases at each branch the tier-one user is responsible. In step 812, the platform processes the order with respective vendors. In step 814, the vendor delivers the items to the branch. Any authorized party may accept the items. When delivery is accepted, the purchases are verified, and the inventory is automatically updated. In step 816, employees of the branch use the items.

In step 818, employees of the branch, including tier-four users, provide ratings for the items purchased on the online shopping platform. In step 820, branch employees, such as the tier-three user, adjust the inventory based on use of items in the inventory management interface on the online shopping platform.

Limiting the input types that a given user (at lower tiers) can submit, causes fewer erroneous user actions that burden the network and system servers. Fewer erroneous server requests reduces the processing/computational cost of system operation.

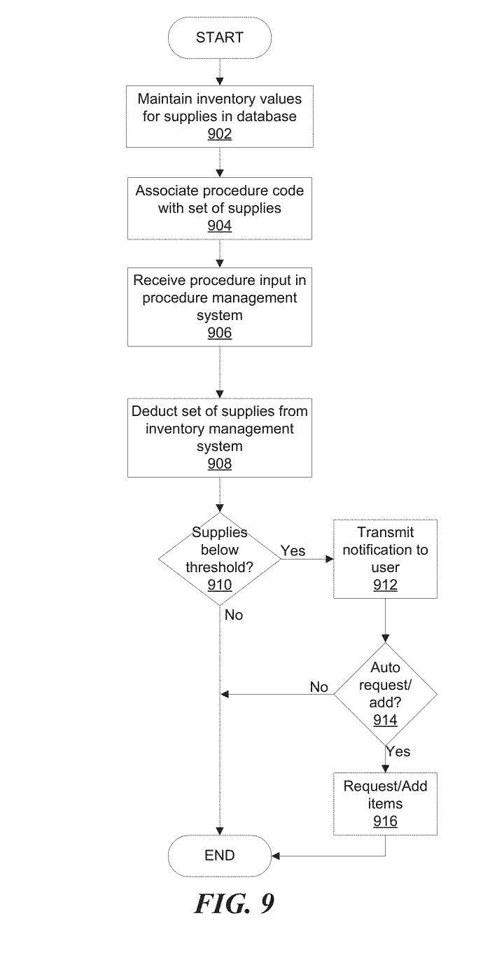

FIG. 9 is a flowchart illustrating integration of an inventory module with a procedure management module. In step 902, an inventory database maintains counts for supplies/items for a given office. In step 904, a procedure management module associates a given procedure (by procedure code) with a predetermined set of supplies. The association of supplies to procedure code may be performed the first time a user enters input that a given procedure (identified by procedure code) had been performed.

In step 906, the procedure management module receives input from a user that a first procedure has been performed (identified by procedure code). In step 908, the procedure management module instructs the inventory management module to deduct the set of supplies (as associated with the first procedure in from step 904) from the inventory database. In step 910, the inventory management module determines whether the supplies for a particular item in the inventory database has fallen below a threshold. The threshold may be determined by user input, or based on historical rate of usage for supplies/items. The threshold may be further influenced by the historical time required to restock. The combination of historical rate of supply depletion and the historical rate of restock after an order for supplies has been placed can be configured such that an inventory will not run out.

Where the threshold has been exceeded, in step 912, the inventory management module transmits a notification to a user (of a preconfigured tier, or multiple tiers). The notification may include interface controls that are configured to either request or add the item (depending on receiving user tier) to the shopping cart associated with the office/location that has low inventory of the item/supplies. In step 914, the inventory system determines whether to automatically request or add the item subject to the threshold to the relevant shopping cart. The determination is made by a predetermined system setting. Where the item is to be automatically requested or added to the cart, in step 916, the system automatically executes the relevant predetermined setting.

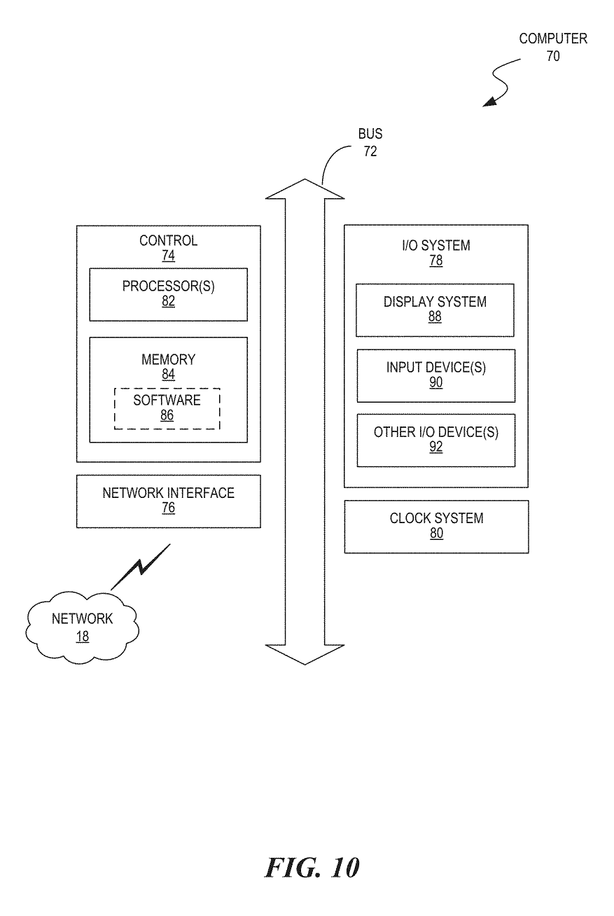

FIG. 10 is a block diagram of a computer 70 operable to implement the disclosed technology according to some embodiments of the present disclosure. The computer 70 may be a generic computer or specifically designed to carry out features of health care system 10. For example, the computer 70 may be a system-on-chip (SOC), a single-board computer (SBC) system, a desktop or laptop computer, a kiosk, a mainframe, a mesh of computer systems, a handheld mobile device, or combinations thereof.

The computer 70 may be a standalone device or part of a distributed system that spans multiple networks, locations, machines, or combinations thereof. In some embodiments, the computer 70 operates as a server computer (e.g., the cost estimator 12 or healthcare information sources 16) or a client device (e.g., consumer devices 14) in a client—server network environment, or as a peer machine in a peer-to-peer system. In some embodiments, the computer 70 may perform one or more steps of the disclosed embodiments in real time, near real time, offline, by batch processing, or combinations thereof.

As shown in FIG. 10, the computer 70 includes a bus 72 that is operable to transfer data between hardware components. These components include a control 74 (e.g., processing system), a network interface 76, an input/output (I/O) system 78, and a clock system 80. The computer 70 may include other components that are not shown nor further discussed for the sake of brevity. One who has ordinary skill in the art will understand elements of hardware and software that are included but not shown in FIG. 10.

The control 74 includes one or more processors 82 (e.g., central processing units (CPUs)), application-specific integrated circuits (ASICs), and/or field-programmable gate arrays (FPGAs), and memory 84 (which may include software 86). For example, the memory 84 may include volatile memory, such as random-access memory (RAM), and/or non-volatile memory, such as read-only memory (ROM). The memory 84 can be local, remote, or distributed.

A software program (e.g., software 86), when referred to as “implemented in a computer-readable storage medium,” includes computer-readable instructions stored in the memory (e.g., memory 84). A processor (e.g., processor 82) is “configured to execute a software program” when at least one value associated with the software program is stored in a register that is readable by the processor. In some embodiments, routines executed to implement the disclosed embodiments may be implemented as part of an operating system (OS) software (e.g., Microsoft Windows® and Linux®) or a specific software application, component, program, object, module, or sequence of instructions referred to as “computer programs.”

As such, the computer programs typically comprise one or more instructions set at various times in various memory devices of a computer (e.g., computer 70), which, when read and executed by at least one processor (e.g., processor 82), will cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., memory 84).

The network interface 76 may include a modem or other interfaces (not shown) for coupling the computer 70 to other computers over the network 18. The I/O system 78 may operate to control various I/O devices, including peripheral devices, such as a display system 88 (e.g., a monitor or touch-sensitive display) and one or more input devices 90 (e.g., a keyboard and/or pointing device). Other I/O devices 92 may include, for example, a disk drive, printer, scanner, or the like. Lastly, the clock system 90 controls a timer for use by the disclosed embodiments.

Operation of a memory device (e.g., memory 84), such as a change in state from a binary one (1) to a binary zero (0) (or vice versa) may comprise a visually perceptible physical change or transformation. The transformation may comprise a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms and that the disclosure applies equally, regardless of the particular type of machine or computer-readable media used to actually effect the embodiments.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method comprising:
generating an inventory management GUI in a web-browser, the inventory management GUI having a plurality of user tiers wherein each user tier has a different GUI with different controls that interact with a plurality of shopping carts; and
receiving user input from a plurality of users of different tiers wherein input received from a user of a first-tier causes a given cart execute an order, input received from a user of a second tier causes an item to be added to the given cart, and input received from a user of a third tier causes a notification to appear to on a second-tier GUI to the user of the second tier requesting the addition of the item to the given cart, wherein users of a given tier do not have controls of tiers above the given tier by default.

2. The method of claim 1, wherein users of a given tier do have controls of tiers below the given tier.

3. The method of claim 1, further comprising:
maintaining a stock database including counts of inventory of a plurality of items;
receiving additional input from a first user that a first medical procedure has been performed;
in response to said receiving additional input, automatically deducting a predetermined set of items from the counts of inventory of the plurality of items based on an identification code for the first medical procedure.

4. The method of claim 3, further comprising:
determining that the count of inventory for the first item has dropped below a threshold; and
in response to said determining, automatically transmitting a notification to the user of the second-tier, via the second tier GUI, the notification including controls configured to add the first item to the given cart.

5. The method of claim 1, wherein input received from a user of a fourth-tier generates a user rating for the item.

6. The method of claim 1, wherein the given cart is a first cart, and the plurality of shopping carts of the inventory management GUI further includes a second cart, the first cart and the second cart having different associated shipping addresses, wherein the user of the first-tier supplies input for both the first cart and the second cart while the users of lower tiers provide input for only one of the plurality of shopping carts.

7. The method of claim 1, wherein the user of a first-tier includes controls to grant users of a lower tier or a specific user account controls accessible by the user of a first-tier.

8. A system for medical supply requisition and management comprising:
a processor operated medical supply purchasing portal accessed via a browser including a first shopping cart on, the first shopping cart having an associated shipping address, the medical supply purchasing portal having a plurality of tier ranked graphic user interfaces (“GUI”), each of the tier ranked GUI having different permissions and controls with respect to the shopping cart, the plurality of tier ranked GUI including all of:
a first-tier GUI including purchase controls for the first shopping cart;
a second-tier GUI including add item controls for the first shopping cart; and
a third-tier GUI including request item controls for the first shopping cart; wherein each of the plurality of tier ranked GUI include controls of lower tiered GUI and do not include controls of higher ranked GUI; and
a processor operated database of user accounts including a plurality of user accounts, each of the plurality of user accounts are associated with only one of the plurality of tier ranked GUI.

9. The system of claim 8, wherein the medical supply purchasing portal further generates a second shopping cart having a different shipping address than the shipping address of the first shopping cart, and wherein the database of user accounts includes a first user account associated with the first-tier GUI that has access and controls with respect to both the first and second shopping carts, and wherein other user accounts associated with the second-tier GUI or third-tier GUI only have access and controls with respect to either the first shopping cart or the second shopping cart.

10. The system of claim 8, further comprising:
a processor supported procedure-to-inventory module in communication with the medical supply purchasing portal, the procedure-to-inventory module automatically reduce an electronic inventory database by a predetermined set of supplies in response to user input indicating that a first medical procedure was performed by a member of a given medical office at the shipping address of the first shopping cart, the first medical procedure identified by a procedure code, the predetermined set of supplies are associated with the first medical procedure.

11. The system of claim 10, wherein the procedure-to-inventory module includes instructions that when executed cause the procedure-to-inventory module to determine that a supply of a first item has gone below a threshold value in the electronic inventory database, and in response, transmit a notification to a user account associated with the second-tier GUI, via the second tier GUI, the notification including controls configured to add the first item to the first shopping cart.

12. The system of claim 8, wherein said plurality of tier ranked GUI further includes:
a fourth-tier GUI including item rating controls configured to apply ratings on items in a medical supply requisition and management system.

13. A method for medical supply requisition and management comprising:
generating a first shopping cart on a medical supply purchasing portal, the first shopping cart having an associated shipping address;
generating a plurality of tier ranked graphic user interfaces (“GUI”), each of the tier ranked GUI having different permissions and controls with respect to the shopping cart, the plurality of tier ranked GUI including all of:
a first-tier GUI including purchase controls for the first shopping cart;
a second-tier GUI including add item controls for the first shopping cart; and
a third-tier GUI including request item controls for the first shopping cart; wherein each of the plurality of tier ranked GUI include controls of lower tiered GUI and do not include controls of higher ranked GUI at a default setting; and
generating a plurality of user accounts, each of the plurality of user accounts are associated with only one of the plurality of tier ranked GUI.

14. The method of claim 13, further comprising:
generating a second shopping cart on a medical supply purchasing portal having a different shipping address than the shipping address of the first shopping cart; and
wherein a first user account associated with the first-tier GUI includes controls with respect to both the first and second shopping carts, and wherein other user accounts associated with the second-tier GUI or third-tier GUI only include controls with respect to either the first shopping cart or the second shopping cart.

15. The method of claim 13, wherein said plurality of tier ranked GUI further includes:
a fourth-tier GUI including item rating controls configured to apply ratings on items in a medical supply requisition and management system.

16. The method of claim 13 further comprising:
receiving input from a first user account associated with the third-tier GUI requesting a first item be added to the first shopping cart; and
transmitting a notification, via the second-tier GUI, to a second user account associated with the second-tier GUI, the notification including controls configured to add the first item to the first cart.

17. The method of claim 16, wherein the notification further identifies the first user account.

18. The method of claim 13, further comprising:
receiving user input on a procedure-to-inventory GUI that a first medical procedure was performed by a member of a given medical office at the shipping address of the first shopping cart, the medical procedure identified by a procedure code; and
in response to said received user input, automatically deducting a predetermined set of supplies from an electronic inventory database associated with the procedure code.

19. The method of claim 18, further comprising:
determining that a supply of a first item has gone below a threshold value in the electronic inventory database;
in response to said determining, automatically transmitting a notification to a user account associated with the second-tier GUI, via the second tier GUI, the notification including controls configured to add the first item to the first shopping cart.

20. The method of claim 18, further comprising:
determining that a supply of a first item has gone below a threshold value in the electronic inventory database;
in response to said determining, automatically transmitting a notification to a user account associated with the third-tier GUI, via the third tier GUI, the notification including controls configured to request addition of the first item to the first shopping cart.

21. The method of claim 13,
receiving input from a first user account associated with the second-tier GUI adding a first item to the first shopping cart; and
transmitting a notification, via the first-tier GUI, to a second user account associated with the first-tier GUI, the notification including controls configured to execute a purchase order on the first cart.

22. The method of claim 13, wherein the first-tier GUI includes controls to grant a lower tier or a specific user account controls accessible by the first-tier GUI.
